(19) United States
(12) Patent Application Publication
(10) Pub. No.: US 2009/0220408 A1
(43) Pub. Date: Sep. 3, 2009

(54) METHOD OF CUTTING CARBON NANOTUBES AND CARBON NANOTUBES PREPARED BY THE SAME

(75) Inventors: CHEOL JIN LEE, SEOUL (KR); KYOUNG YONG CHUN, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: KOREA UNIVERSITY INDUSTRIAL & ACADEMIC FOUNDATION, SEOUL (KR)

(21) Appl. No.: 12/040,846

(22) Filed: Feb. 29, 2008

(51) Int. Cl. C01B 31/02

(52) U.S. Cl. 423/447.2; 423/447.3

(57) ABSTRACT

A method of cutting carbon nanotubes and carbon nanotubes prepared by the same are disclosed. The cutting method includes preparing a π-stacking complex including a doping metal, a non-polar molecule, and a bipolar solvent, adding carbon nanotubes to the π-stacking complex, followed by stirring at room temperature to prepare a metal-doped carbon nanotube solution, washing and drying the metal-doped carbon nanotube solution to prepare a metal-doped carbon nanotube powder, and performing nitric acid treatment to the metal-doped carbon nanotube powder, followed by cutting and washing with distilled water. Carbon nanotubes having a short and uniform length and open terminals can be produced in mass via a simple process, thereby expanding the uses and applications of carbon nanotubes.

### BACKGROUND OF THE INVENTION

1. Field of the Invention

The present invention relates to a method of cutting carbon nanotubes and carbon nanotubes prepared by the same, and more particularly to a method of cutting carbon nanotubes, in which carbon nanotubes are doped with a predetermined metal to facilitate dispersion of carbon nanotubes and are nitrated to ensure efficient cutting for achieving improved applicability, and carbon nanotubes prepared by the same.

2. Description of the Related Art

Carbon nanotubes were discovered as by-products from synthesis of fullerene by Sumio Iijima of NEC Research Institute in 1991 and have properties such as physical solidness, excellent chemical stability, high thermal conductivity, and hollowness. Carbon nanotubes are employed in a variety of applications including electrodes of electrochemical storage devices, such as an electromagnetic shield, a secondary battery, a fuel cell, and a super capacitor, electron dischargers of Field Emission Displays (FEDs), electron amplifiers, gas sensors, etc. Further, new carbon nanotube applications are continuously being discovered.

To improve the applicability of carbon nanotubes, it is necessary that they be dispersed or cut into a bundle of micro-scale tubes or into separate nano-scale tubes.

As is known in the art, carbon nanotubes can be dispersed by chemical treatments, adhesion of surfactants, polymerization, and a process employing a carbon nanotubes-polymer complex and an organic molecule (Xia H., Wang Q. and Qiu G., Polymer-encapsulated carbon nanotubes prepared through ultrasonically initiated in situ emulsion polymerization. Chem. Mater, Vol. 15, pp. 3879-3886, 2003; Curran S A, Ajayan P M, Blau W J, Carroll D L, Coleman J N, Dalton A B, et al., Composite from poly(m-phenylenevinylene-co-2,5-dioctoxy-p-phenyleneviand) and carbon nanotubes: a novel material for molecular optoelectronics, Adv. Master, Vol. 10, pp. 1091-1093, 1998, etc.).

As a method of dispersing carbon nanotubes, two different approaches, i.e. physical and chemical methods, have been generally proposed. In the physical method, carbon nanotubes are separated from each other by an ultrasonic treatment or mechanical cutting, such as milling, which can cause severe damage to the carbon nanotubes. The chemical method is directed to decrease cohesion between carbon nanotubes in a liquid phase while improving wettability thereof, and includes covalent and non-covalent functionalization reactions. However, the chemical method can also cause damage of carbon nanotubes or can introduce impurities into the carbon nanotubes.

Further, a conventional dispersion or cutting method has disadvantages in that carbon nanotubes have deteriorated properties, are produced at low yields (milligram scale), cut unevenly in length, and have closed terminals.

Thus, there is a need for mass production of carbon nanotubes cut in a short and uniform length and having open terminals for various applications.

### SUMMARY OF THE INVENTION

The present invention is conceived to solve the problems of the conventional techniques as described above, and an aspect of the present invention is to provide a method of cutting carbon nanotubes, in which carbon nanotubes are doped with a predetermined metal to facilitate dispersion of carbon nanotubes and are nitrated to ensure efficient cutting for achieving improved applicability.

It is another aspect of the invention to provide carbon nanotubes prepared by the method of the present invention.

According to one aspect of the invention, the present invention provides a method of cutting carbon nanotubes including: preparing a π-stacking complex including a doping metal, a non-polar molecule, and a bipolar solvent; adding carbon nanotubes to the π-stacking complex, followed by stirring at room temperature to prepare a metal-doped carbon nanotube solution; washing and drying the metal-doped carbon nanotube solution to prepare a metal-doped carbon nanotube powder; and performing nitric acid treatment to the metal-doped carbon nanotube powder, followed by cutting and washing with distilled water.

The doping metal may be an alkali metal selected from the group consisting of lithium, sodium, and potassium.

The non-polar molecule may be an aromatic carbon compound selected from the group consisting of naphthalene, anthracene, and phenanthrene.

The bipolar solvent may be an organic solvent selected from the group consisting of tetrahydrofuran, methyltetrahydrofuran, diethoxyethane, and dimethylethyl ether.

The π-stacking complex may include 1 to 2 parts by weight of the doping metal and 3.0 to 3.5 parts by weight of the non-polar molecule with respect to 100 parts by weight of the bipolar solvent.

0.5 to 1 part by weight of the carbon nanotubes may be added to 100 parts by weight of the π-stacking complex.

The stirring may be performed at a speed of 300˜500 rpm at room temperature under a nitrogen atmosphere for three hours to one week.

The washing may be performed with at least one washing solution selected from the group consisting of water, alcohol, dimethylformamide, chloroform, dichlorobenzene, tetrahydrofuran, and dimethylacetamide.

The nitric acid may have a concentration of 5% to 60%.

The nitric acid treatment may be performed at room temperature to 118° C. for 2 to 12 hours.

In accordance with another aspect of the invention, the present invention provides carbon nanotubes prepared by the method of cutting carbon nanotubes.

The method according to the present invention enables mass production of cut carbon nanotubes having a short and uniform length and open terminals via a simple process, expanding the uses and applications of carbon nanotubes.

### BRIEF DESCRIPTION OF THE DRAWINGS

The above and other objects, features and advantages of the present invention will become apparent from the following description of preferred embodiments given in conjunction with the accompanying drawings, in which:

FIG. 1 show the UV absorption spectrum of metal-doped carbon nanotubes dispersed in ethanol according to the present invention;

FIG. 2 is an SEM image of the metal-doped carbon nanotubes dispersed in ethanol according to the present invention;

FIGS. 3a and 3b are TEM images of conventional carbon nanotubes (FIG. 3a) and the metal-doped carbon nanotubes (FIG. 3b) according to the present invention;

FIGS. 4a and 4b show the Raman spectrum of carbon nanotubes in an initially synthesized state and the Raman spectrum of the metal-doped carbon nanotubes according to the present invention; and

FIGS. 5a and 5b are TEM images of metal-doped carbon nanotubes nitrated at room temperature (FIG. 5a) and metal-doped carbon nanotubes nitrated at 118° C. (FIG. 5b).

### DETAILED DESCRIPTION OF THE INVENTION

Exemplary embodiments of the present invention will be described in detail with reference to the accompanying drawings.

According to one exemplary embodiment of the present invention, a method of cutting carbon nanotubes includes preparing a π-stacking complex, preparing a metal-doped carbon nanotube solution, preparing a metal-doped carbon nanotube powder, and performing a nitric acid treatment to the metal-doped carbon nanotube powder.

The π-stacking complex is employed to prepare a metal-doped carbon nanotube powder from a metal-doped carbon nanotube solution having improved dispersibility of carbon nanotubes, and includes a doping metal, a non-polar molecule, and a bipolar solvent. That is, the π-stacking complex is a complex of the doping metal, non-polar molecule and bipolar solvent, and serves to dope carbon nanotubes with a metal.

More specifically, since the non-polar molecule has a remarkably high electron affinity, electrons are drawn from the doping metal into the non-polar molecule. Then, the doping metal deprived of electrons forms a coordinate bond with the bipolar solvent and combines with anion radicals of the non-polar molecule. Subsequently, holes are formed on the surface of a carbon nanotube network by the molecules having the coordinate bonds, and are finally doped with the doping metal.

Thus, the doping metal is a metal that tends to be deprived of electrons by the non-polar molecule, and preferably, but is not limited to, an alkali metal selected from the group consisting of lithium, sodium, and potassium.

The non-polar molecule is a metal with a higher electron affinity than the doping metal, and preferably, but is not limited to, an aromatic carbon compound selected from the group consisting of naphthalene, anthracene, and phenanthrene.

An example of the bipolar solvent suitable to form the π-stacking complex includes, but is not limited to, an organic solvent selected from the group consisting of tetrahydrofuran, methyltetrahydrofuran, diethoxyethane, and dimethylethyl ether.

As relative contents of the doping metal, non-polar molecule, and bipolar solvent to form the π-stacking complex, it is preferable to have 1 to 2 parts by weight of the doping metal and 3.0 to 3.5 parts by weight of the non-polar molecule with respect to 100 parts by weight of the bipolar solvent. When an excess of one of the doping metal, non-polar molecule, and bipolar solvent is included, unnecessary precipitates form, thereby casing trouble in formation of the π-stacking complex. In particular, when too much doping metal is present, there is a risk of explosion in a post treatment when the carbon nanotubes are brought into contact with water or air, and thus, excessive amounts of doping metal must not be added.

After forming the π-stacking complex as described above, carbon nanotubes are added to the π-stacking complex and stirred at room temperature, thereby preparing a metal-doped carbon nanotube solution.

When adding carbon nanobtubes to the π-stacking complex, the carbon nanotubes are preferably added at 0.5 to 1 part by weight with respect to 100 parts by weight of the π-stacking complex. If the amount of carbon nanotubes is below this range, an unreacted π-stacking complex can be generated. If the amount of carbon nanotubes exceeds this range, the π-stacking complex does not sufficiently react with the carbon nanotubes so that effects of the present invention cannot be achieved sufficiently.

Stirring is performed at a speed of 300˜500 rpm at room temperature under a nitrogen atmosphere for three hours to one week.

Next, a metal-doped carbon nanotube solution where holes formed on the surface of a carbon nanotube network are doped with a doping metal is obtained, followed by washing and drying to prepare a metal-doped carbon nanotube powder.

Washing may be performed to remove unreacted alkali metals, and employ, but is not limited to, at least one washing solution selected from the group consisting of water, alcohol, dimethylformamide, chloroform, dichlorobenzene, tetrahydrofuran, and dimethylacetamide. More preferably, washing may be performed several times with alcohol.

According to the present invention, a metal-doped carbon nanotube powder having further improved dispersibility is prepared and subjected to nitric acid treating, cutting, and washing with distilled water, thereby producing carbon nanotubes having a uniform and short length.

Conventionally, nitric acid treatment is performed without pre-treatment such as dispersion. However, in the method of cutting carbon nanotubes via metal doping and nitric acid treatment according to the present invention, the nitric acid treatment is performed after separation and dispersion of a bundle of entangled carbon nanotubes to efficiently cut carbon nanotubes. Thus, the method of the invention is useful to adjust the length of carbon nanotubes and to suppress destruction of carbon nanotubes by proper nitric acid treatment, which is far more advantageous than the conventional cutting method based on simple nitric acid treatment.

According to the present invention, the nitric acid treatment is preferably performed using nitric acid with a concentration of 5% to 60%. If the concentration of nitric acid is less than 5%, there are limitations in adjusting the length of cut carbon nanotubes. If the concentration of nitric acid is more than 60%, the surfaces and cut portions of carbon nanotubes can be severely damaged.

Further, the nitric acid treatment is preferably performed at room temperature to 118° C. for two to twelve hours. If the temperature is excessively high or low, carbon nanotubes are not efficiently cut or are severely destroyed. If the reaction time is excessively short or long, carbon nanotubes are not cut, or time is wasted.

Meanwhile, another aspect of the present invention is to provide carbon nanotubes prepared by the method of the present invention as described above. Carbon nanotubes according to the present invention are short and uniform in length and have open terminals, and thus, they can be employed in a variety of applications including electrodes of electrochemical storage devices, such as an electromagnetic shield, a secondary battery, a fuel cell, and a super capacitor, electron dischargers of FEDs, electron amplifiers, gas sensors, etc.

The present invention will hereinafter be described in detail with reference to examples. It should be noted that these examples are given by way of illustration only and do not limit the scope of the present invention.

### EXAMPLES

Preparation of Carbon Nanotubes

A catalytic reaction of C₂H₄ was proceeded in the presence of a catalyst of Fe/MgO under an Ar/H₂ atmosphere at 900° C. to prepare high purity multi-wall carbon nanotubes with 99% purity. In detail, Fe(NO₃)₃.9H₂O (99%, Aldrich) dissolved in distilled water was added to a solution of MgO powder and distilled water and was stirred for one hour such that a metal catalyst of Fe was embedded in the MgO powder. Subsequently, after burning and pulverizing the product, 50 mg of the catalyst was loaded in a quartz boat and placed in the middle of a quartz tube (i.d.: 20 mm, length: 500 mm). A gas mixture of Ar:H₂/C₂H₄ was introduced into the quartz tube at a flux of 1300 sccm (Ar:H₂/C₂H₄, 500:500/300) and at 900° C., and maintained at the same flux under an Ar/H₂ atmosphere until the quartz tube cooled to room temperature. The produced multi-wall carbon nanotubes had an average diameter of 20 nm and about 15 grapheme layers.

Preparation of π-Stacking Complex

A π-stacking complex solution including 200 parts by weight of potassium to 100 parts by weight of carbon nanotubes, 0.2 mol/dm³ phenanthrene (99%), and 20 ml of 1,2-DME (99.5%) was prepared. The reagents are available from Aldrich Chemical Co. Inc.

Preparation of Metal-Doped Carbon Nanotubes

50 mg of the multi-wall carbon nanotubes was added to the π-stacking complex and was stirred with a magnetic stirrer at room temperature for 48 hours. The resulting metal-doped carbon nanotubes were washed with ethanol and water several times, and dried.

The obtained metal-doped carbon nanotube powder was analyzed with ethanol as a dispersion medium using a UV-visible spectroscope (Shimadzu, UV-3101), a scanning electron microscope (SEM: Hitachi S-4700), a high-resolution transmission electron microscope (HRTEM: JEOL, JEM-3011, 300 kV), and a Raman spectrometer (Ranishaw RM 1000, 514 nm, Ar-laser excitation) to determine dispersibility thereof.

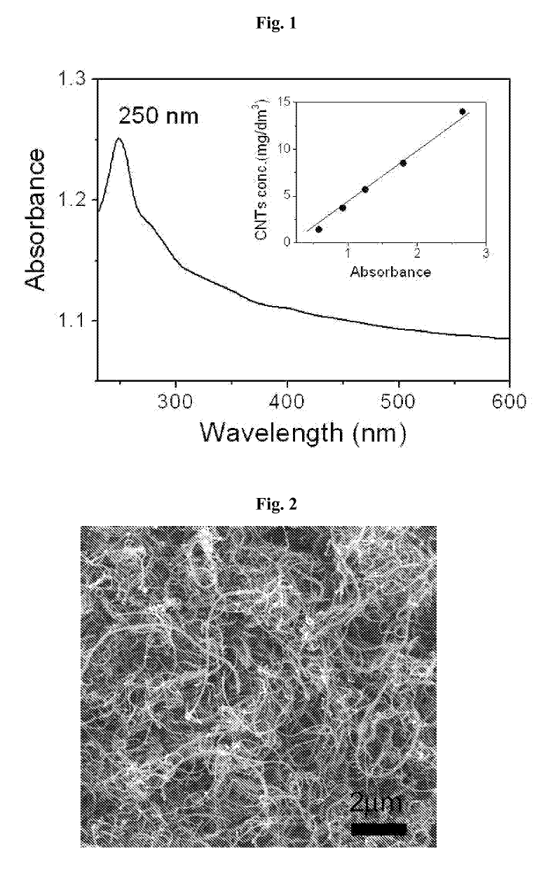

FIGS. 1 and 2 are the UV absorption spectrum and an SEM image of the metal-doped carbon nanotubes dispersed in ethanol according to the present invention. FIG. 1 shows the UV absorption spectrum of the metal-doped carbon nanotubes dispersed in ethanol at a concentration of 5.7 mg/dm³. In FIG. 1, it can be appreciated that a broad absorption peak is observed at 250 nm due to carbon nanotubes sufficiently dispersed in ethanol. Also, a graph indicated by the box in FIG. 1 shows that the absorption increases proportional to the concentration of carbon nanotubes up to 1-14 mg/dm³. In FIG. 2, it can be appreciated that the metal-doped carbon nanotubes form a stacked structure.

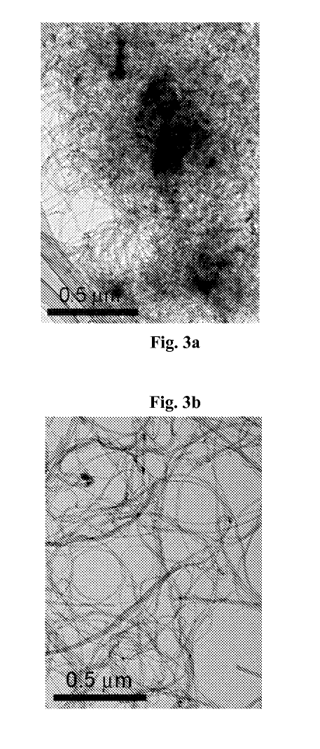

FIGS. 3a and 3b are TEM images of conventional carbon nanotubes (FIG. 3a) and metal-doped carbon nanotubes (FIG. 3b) according to the present invention. As shown in FIG. 3a, the conventional carbon nanotubes exhibit considerably low dispersibility and exist in a severely cohesive state, whereas the carbon nanotubes of the present invention exhibit excellent dispersibility, as shown in FIG. 3.

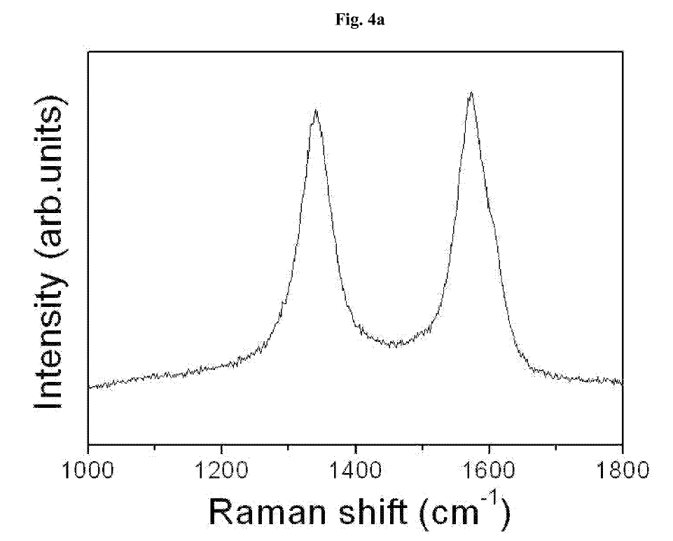

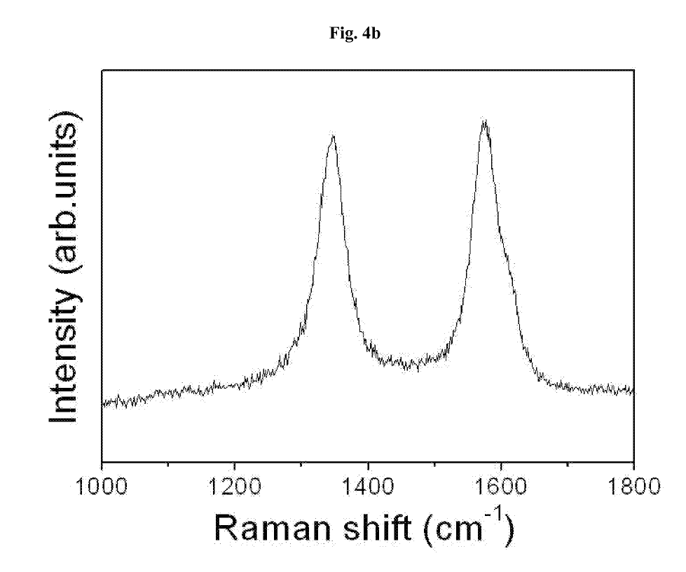

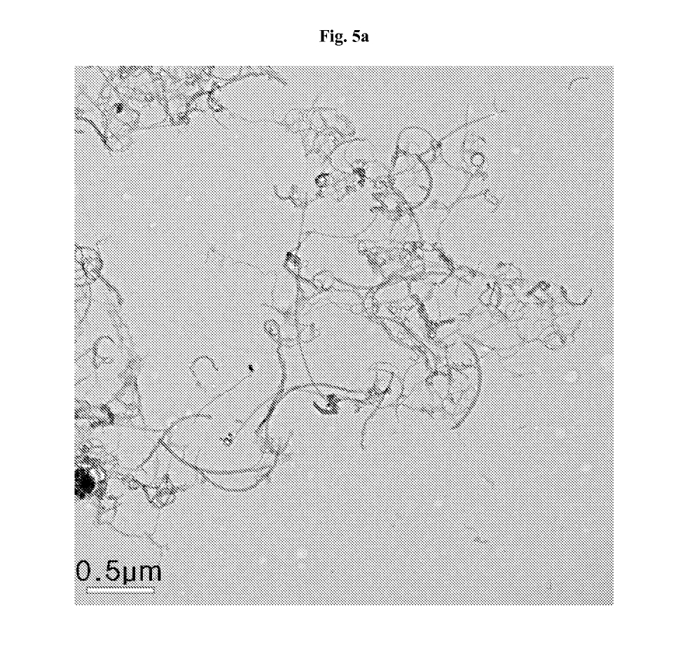

FIGS. 4a and 4b show the Raman spectrum of carbon nanotubes in an initially synthesized state and the Raman spectrum of metal-doped carbon nanotubes according to the present invention. Although it is generally known that carbon nanotubes having reacted with an alkali metal have G and D bands significantly shifted in width, the Raman spectrum of metal-doped carbon nanotubes according to the present invention shows G and D bands considerably similar to those of carbon nanotubes when they are synthesized. Accordingly, the carbon nanotubes do not suffer from superficial defects or deformation by metal doping in the present invention.

Nitric Acid Treatment

About 100 ml of nitric acid (60%) was placed into a 250 ml single-neck round-bottom flask, and 100 mg of the obtained metal-doped carbon nanotubes was added thereto to perform nitric acid treatment.

Nitric acid treatment was performed at two different temperatures to produce two samples. One sample was reacted at room temperature. The other sample was reacted in the round-bottom flask, a neck of which was connected to a reflux pipe, by heating to about 118° C. in a double boiler with oil. Each sample was reacted for about 12 hours. The resultant products were then diluted with distilled water several times and were filtered several times. Subsequently, the products were sufficiently washed so that no nitration by-product remained, thereby obtaining finished cut carbon nanotubes.

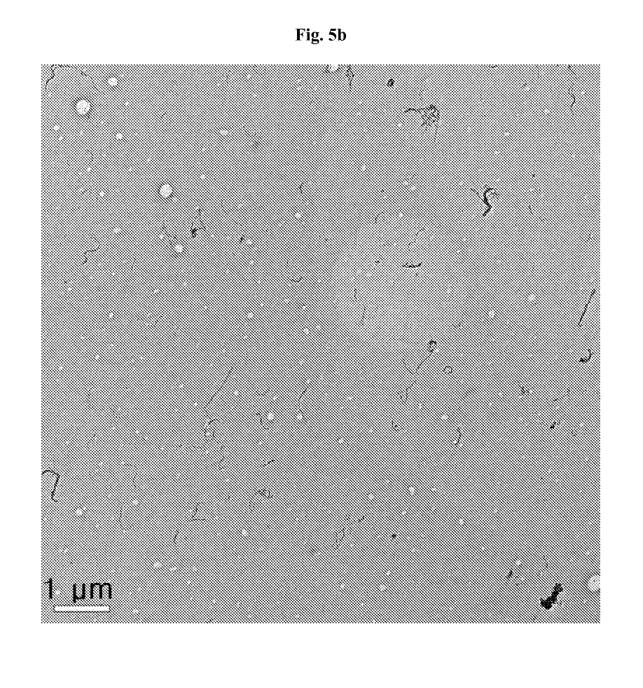

FIG. 5a is a TEM image of carbon nanotubes cut at room temperature, showing that the carbon nanotubes are effectively cut. FIG. 5b is a TEM image of carbon nanotubes cut at 118° C., showing that the carbon nanotubes are shorter than those cut at room temperature. Hence, carbon nanotube length can be adjusted by varying temperature.

As apparent from the above description, the method according to the present invention enables mass production of cut carbon nanotubes having a short and uniform length and open terminals via a simple process, expanding the uses and applications of carbon nanotubes.

Although the embodiments have been described with reference to the accompanying drawings, the present invention is not limited to the embodiments and the drawings. It should be understood that various modifications and changes can be made by those skilled in the art without departing from the spirit and scope of the present invention as defined by the accompanying claims.

1-11. (canceled)

12. A method of carbon nanotubes, the method comprising:
providing a π-stacking complex comprising a doping metal, a non-polar molecule, and a bipolar solvent;
adding carbon nanotubes to the π-stacking complex so as to provide a metal-doped carbon nanotube solution;
drying the metal-doped carbon nanotube solution to provide a metal-doped carbon nanotube powder; and
performing a nitric acid treatment to the metal-doped carbon nanotube powder, followed by cutting.

13. The method of claim 12, wherein the doping metal comprises an alkali metal.

14. The method of claim 12, wherein the doping metal is at least one selected from the group consisting of lithium, sodium, and potassium.

15. The method of claim 12, wherein the non-polar molecule comprises an aromatic carbon compound.

16. The method of claim 12, wherein the non-polar molecule is at least one selected from the group consisting of naphthalene, anthracene, and phenanthrene.

17. The method of claim 12, wherein the bipolar solvent is at least one organic solvent selected from the group consisting of tetrahydrofuran, methyltetrahydrofuran, diethoxyethane, and dimethylethyl ether.

18. The method of claim 12, wherein in the π-stacking complex the doping metal is in an amount of 1 to 2 parts by weight with respect to 100 parts by weight of the bipolar solvent.

19. The method of claim 12, wherein in the π-stacking complex the non-polar molecule is in an amount of 3.0 to 3.5 parts by weight with respect to 100 parts by weight of the bipolar solvent.

20. The method of claim 12, wherein the carbon nanotubes added are 0.5 to 1 part by weight with reference to 100 parts by weight of the π-stacking complex.

21. The method of claim 12, further comprising stirring the π-stacking complex and carbon nanotube subsequent to adding.

22. The method of claim 21, wherein the stirring is performed at a speed of 300 to 500 rpm under a nitrogen atmosphere.

23. The method of claim 12, further comprising washing the metal-doped carbon nanotube solution.

24. The method of claim 23, wherein the washing is performed using at least one washing solution selected from the group consisting of water, alcohol, dimethylformamide, chloroform, dichlorobenzene, tetrahydrofuran, and dimethylacetamide.

25. The method of claim 12, wherein the nitric acid has a concentration of 5% to 60%.

26. The method of claim 12, wherein the nitric acid treatment is performed at a temperature between room temperature and 118° C. for 2 to 12 hours.

27. Carbon nanotubes prepared by the method of claim 12.
